(19) United States
(12) Patent Application Publication
(10) Pub. No.: US 2003/0061481 A1
(43) Pub. Date: Mar. 27, 2003

(54) Secure broadcast system and method

(76) Inventors: David Levine, Scotts Valley, CA (US); Ron Cain, Scotts Valley, CA (US); Sidney Markowitz, Santa Cruz, CA (US)

Correspondence Address: GARY CARY WARE & FREIDENRICH LLP, 1755 EMBARCADERO ROAD, PALO ALTO, CA, 94303-3340, US

(21) Appl. No.: 10/259,060

(22) Filed: Sep. 26, 2002

Related U.S. Application Data
(60) Provisional application No. 60/325,250, filed on Sep. 26, 2001.

(51) Int. Cl. H04L 9/00

(52) U.S. Cl. 713/163

(57) ABSTRACT

A secure and scalable broadcast system and method of creating the same, having a plurality of nodes connected to a network with pre-positioned public/private encryption keys, including at least one root node for publishing digital messages, a plurality of interior nodes for relaying the published digital messages, and a plurality of leaf nodes for receiving the published and relayed messages. Each digital message includes an encrypted payload, and a symmetric key for decrypting the payload. The root and interior nodes publish and relay the message by encrypting the symmetric key with the public key of each node that will receive the published/relayed message from that node. Each interior and leaf node decrypts the symmetric key using its private key. Only the leaf nodes decrypt the message payload using the symmetric key. A back channel sends messages from the leaf nodes to the root nodes in the same manner.

This application claims the benefit of U.S. Provisional Application No. 60/325,250, filed Sep. 26, 2001, and entitled Method for broadcasting large data amount to large number of remote computing devices with return receipt.

### FIELD OF THE INVENTION

The present invention relates to a secured broadcast system and method, and more particularly to a broadcast system and method for efficient, secure, reliable and scalable broadcast of digital messages to large numbers of recipients.

### BACKGROUND OF THE INVENTION

There is a well established need to secure digital broadcasts that are required across several different market segments or application domains, including but not limited to: secure messaging, secure content exchange, broadcast media, conferencing, eLearning, collaboration, networked computer gaming, edge cache management, and software deployment. All these different domains share a need to broadcast potentially large amounts of data securely to potentially many endpoints, and may include the need to handle endpoints that are offline during any part of the broadcast.

As used herein, broadcast is defined very broadly as meaning transmission of digital data (e.g. computer messages with header information and payload data) over a data network to one or more recipients. However, unlike normal radio or television broadcasts which may be received by any recipient within the broadcast reception area, secure broadcasts may only be decrypted by authorized recipients. The term broadcast is also used herein independently of any particular protocol, and in fact multiple protocols may be utilized simultaneously (possibly involving protocol conversion), either in parallel or in series.

In addition, the above mentioned application domains also share a need for a secure back channel. A back channel is often used to transmit status information, quality of service information, billing information, or other data, from the recipient to the originator of the broadcast. A back (reverse) channel has different security scaling issues compared to the main (forward) broadcast channel. Specifically, each recipient sending data through the back channel must individually sign its data, and encrypt it such that only the original source of the broadcast can decrypt the data. Furthermore, all back channel information must be accessible from the point of origination of the broadcast, in such a way that the broadcast originator is not swamped with responses that in number are the equivalent of a denial of service attack.

In order to have a broadcast system that truly scales, the scalability of both the broadcast side and the back channel side must be addressed. Scalability is very important for networks with a large number of recipients (i.e. thousands, tens of thousands, or more), where the network membership is constantly changing. More specifically, the problems which must be addressed are:

1. How should the broadcast system encrypt and digitally sign the broadcasted data only once, regardless of the number of recipients, the network topology, the protocol(s) used, the platform or operating systems of recipients, and the quality of network connection.

2. How should the broadcast system securely distribute a shared session key in a way that scales even with very large groups having constantly changing membership, and while allowing for distributions to subsets of those groups.

3. How should the broadcast system process secure back channel information received from large numbers of recipients as a result of a broadcast.

4. How can the broadcast system provide redundancy for reliability, without duplicating messages, yet not create bottlenecks that delay data delivery.

Generally, in order to secure a broadcast, the data must be encrypted with a secret key, and that key must be distributed securely to all the recipients prior to the actual broadcast. There are two general approaches to doing this:

A. The secret key can be associated with a static broadcast group. With this approach, prior to any broadcast, the secret key is distributed securely to all group members. A problem with this approach is that the group must be re-keyed if a member leaves the group, and in some cases when a member joins the group as well. If the size of the group is sufficiently large and the group undergoes a sufficiently large number of changes, the re-keying process can swamp the network. Another problem with this approach is that a broadcast can not be targeted to a subset of the broadcast group, without essentially defining a new group with its own secret key. Groove (by Network Groove) is an example of a product that uses this approach.

B. The secret key can be associated with a particular broadcast stream. With this approach, the secret key is distributed as a header to the actual broadcast stream, where each stream contains its own unique key. The main problem with this approach is that the size of the header is proportional to the number of recipients, and the header must be broadcast to all recipients. If the number of recipients is sufficiently large, the size of the header relative to the size of the broadcast stream can be excessively large and swamp the network. In addition, the computation time required to create the header can be prohibitive. S/MIME and PKCS#7 are two standards that support this approach. These standards are widely used in both email and document management systems.

Whichever of these two approaches is used, a secret key still must be securely transmitted to all the recipients. This is typically accomplished using public/private key technology. Public/private key technology is also used to digitally sign data, which is required for both the broadcast and the back channel. Unfortunately, the process of distributing the certificates required for secret key distribution and digital signatures can be quite complex. Existing systems accomplish certificate distribution by either using a general purpose public key infrastructure (PKI) integrated with a broadcast technology (which is a costly and time consuming process), or by using a certificate distribution process built-in to the broadcast system (which generally limits the use of certificates to the particular broadcast application). Existing certificate distribution systems for broadcasting also fail to consider topologies that are more complex than simple hub (server) and spoke (client), and therefore contain built-in scalability limitations.

There is a need for a system that provides a secure broadcast system with a back channel that can:

define large, dynamic groups for the purpose of the broadcast;

efficiently address subsets of the group for a broadcast;

automatically create, sign and distribute the certificates required to distribute the secret key and for signing all transmissions on a need-to-know basis;

manage the security for the broadcast without overhead that swamps the computing devices or the network participating in the broadcast;

establish secure back channels through which the originator of the broadcast may securely access data transmitted from large numbers of recipients;

keep the identity of recipients confidential, such that one recipient can not determine the identity of any other recipient;

maintain end-to-end encryption through intermediate points, such that data is only encrypted once at the source of the broadcast, regardless of how many intermediate computing elements process that data, so that data is not decrypted until it reaches an authenticated end point;

transmit the same encrypted data over multiple protocols either simultaneously or serially, without requiring re-encryption, including store-and-forward archiving for subsequent retrieval by receivers that are not online during the actual broadcast, and possibly including protocol converters to span network segments.

### SUMMARY OF THE INVENTION

The present invention is a broadcast system that includes a plurality of nodes connected to a network of connection paths for broadcasting digital messages. The plurality of nodes includes a root node for publishing the digital messages over the network, wherein each of the published digital messages includes an encrypted payload of data and an encrypted key for decrypting the payload, an interior node for relaying any of the published digital messages received thereby by decrypting the encrypted key, by re-encrypting the decrypted key, and by relaying the digital message over the network with the re-encrypted key and the encrypted payload, and a leaf node for processing any of the relayed digital messages received thereby by decrypting the re-encrypted key, and by decrypting the payload using the decrypted key.

In another aspect of the present invention, a broadcast system includes a plurality of nodes connected to a network of connection paths for broadcasting digital messages. The plurality of nodes includes at least one root node, having one or more of the plurality of nodes designated as direct recipient node(s) thereof, for publishing the digital messages over the network only to the direct recipient node(s) of the root node, wherein each of the published digital messages includes an encrypted payload of data and an encrypted payload key for each of the direct recipient node(s) of the root node, a plurality of interior nodes, each having one or more of the plurality of nodes designated as direct recipient node(s) thereof, for relaying any of the digital messages received thereby by decrypting the encrypted payload key for the interior node, by using the decrypted payload key to create and insert into the digital message an encrypted payload key for each of the direct recipient node(s) of the interior node, and by sending the digital message over the network only to the direct recipient node(s) of the interior node, and a plurality of leaf nodes each for processing any of the digital messages received thereby by decrypting the encrypted payload key for the leaf node, and by decrypting the payload using the decrypted payload key.

In yet another aspect of the present invention, a method creates a secure broadcast group for a broadcast system having a plurality of nodes connected to a network of connection paths. The method includes the steps of defining a broadcast group by designating at least some of the plurality of nodes as authorized nodes for joining the group, and by designating for each of the authorized nodes which of the authorized nodes are allowed to receive broadcast messages therefrom, and joining the authorized nodes to the group by conveying to each of the authorized nodes an identity and a public encryption key of any of the authorized node(s) designated as allowed to receive broadcast messages therefrom.

Other objects and features of the present invention will become apparent by a review of the specification, claims and appended figures.

### BRIEF DESCRIPTION OF THE DRAWINGS

FIG. 1 is a diagram illustrating the components of the broadcast system of the present invention.

FIG. 2 is a is flow diagram illustrating the steps of defining the broadcast groups of the present invention.

FIG. 3 is a is flow diagram illustrating the steps of joining nodes to the broadcast groups of the present invention.

FIG. 4 is a is flow diagram illustrating the steps of originator publishing of messages over the broadcast system of the present invention.

FIG. 5 is a is diagram illustrating the components of a digital message published over the broadcast system of the present invention.

FIG. 6 is a is flow diagram illustrating the steps of relaying messages over the broadcast system of the present invention.

FIG. 7 is a is flow diagram illustrating the steps of recipient processing of messages by the broadcast system of the present invention.

### DETAILED DESCRIPTION OF THE PREFERRED EMBODIMENTS

The present invention is a broadcast system and method, and method of setting up the same, for broadcasting digital messages (i.e. digital information potentially including large amounts of digital data) to potentially large numbers of recipients with a high level of security, reliability, and performance. The broadcast system architecture utilizes multiples layers of nodes with security certificates pre-positioned on a need to know basis for automatic, scalable and secure publication and relaying of digital messages. Message relaying is performed without decrypting the messages' payload, ensuring it is received at its final destination without being modified. A secure back channel gathers and centralizes information from recipients. The broadcast system utilizes pre-positioned security certificates to ensure each transmission of the broadcasted message is secure.

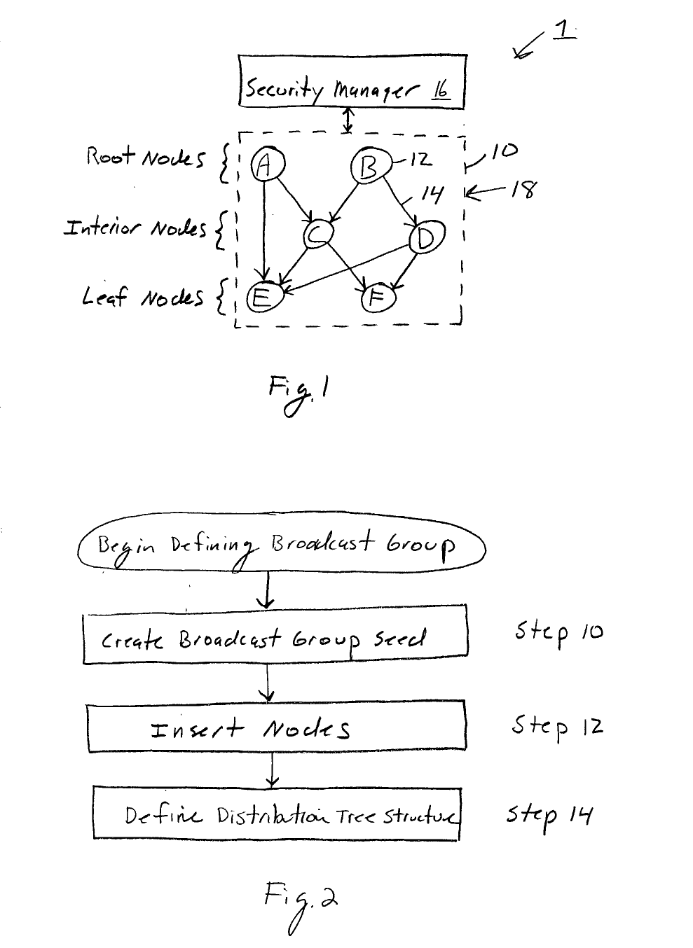

FIG. 1 illustrates an example broadcast system 1 of the present invention, with a sample broadcast tree structure 10. The broadcast tree structure 10 includes a plurality of nodes 12 connected together via standard network connections 14, where the nodes 12 are indicated by the letters A through G. Typically, each node 12 is a discrete electronic device, but a plurality of nodes 12 can be resident on a single electronic device (e.g. an interior node and a leaf node can be resident on the same computing device). Each node 12 has two properties: a logical name or address that may be presented in a user interface, and a Globally Unique Identifier (GUID) which is the internal identification token for that node. The various network connections 14 can utilize different protocols and hardware configurations, but together form a broadcast network 18 that connects together the nodes of the broadcast system 1 in a selective manner.

The broadcast tree of FIG. 1 is an acyclic digraph, with three levels of nodes: root nodes (e.g. nodes A and B), interior nodes (e.g. nodes C and D), and leaf nodes (e.g. nodes E and F). The root nodes serve as the publisher of the digital messages, interior nodes serve to relay the broadcasted digital messages from the root nodes to the leaf nodes, and the leaf nodes represent the intended recipients of the broadcasted digital messages. Although there are only two nodes illustrated in each level of the broadcast tree 10, this broadcast tree can be expanded to include thousands or even millions of nodes in the various levels, and can include a plurality of interior node levels. Some of the properties of broadcast tree 10 are that digital messages can be broadcast from any of the root nodes to any proper subset of the leaf nodes, leaf nodes may then return status information back to the originating root node, multiple root nodes are allowed, the in-degree (i.e. the number of nodes that directly send digital messages to a particular node) at any non-root level can be greater than 1, leaf nodes may be reached by a combination of root and interior nodes, every root node can reach every leaf node through at least one path, and cycles between nodes (i.e. a node repeatedly receiving and resending the same message) is prevented.

The broadcast system 1 also includes at least one security manager 16 that can communicate with all the nodes 12 in the broadcast tree 10 (via its own network and/or network 18). Among other duties, the security manager(s) can act as a standard certificate authority, as explained further below. The security manager(s) can be resident on separate computing devices, can be combined together on a single computing device, and can even be resident on a computing device containing one or more of the nodes 12.

The interior nodes of the broadcast tree can be omitted, so that the root nodes broadcast directly to the leaf nodes. However, most implementations of the broadcast system of the present invention will include at least one layer of interior node(s) to reduce the broadcast load of the root node(s), to reduce the load on long haul network connections, to provide protocol conversion between nodes, to provide additional security (e.g. act as a firewall), and to provide parallel dispersion paths (parallel network connections) to increase the speed of the broadcast system and to provide alternate dispersion paths should a node or network connection fail. Interior nodes also provide load balancing, as will be described further detail below.

While the particular network(s) used to link the nodes together may physically allow some or even all nodes to communicate with each other, the arrows in FIG. 1 illustrate those communication paths (network connections) between the various nodes 12 that are authorized by the broadcast tree structure to disseminate the broadcasted digital messages. Therefore, every root and interior node has its own set of authorized “direct recipient node(s)”, which are those nodes lower in the broadcast tree that are authorized to directly receive digital broadcast messages from the one node. For example, node A in FIG. 1 has two direct recipient nodes: C and E; node D has two direct recipient nodes: E and F, and so on. Thus, the broadcast tree structure defines a secure (forward) “broadcast channel” by limiting the network connection paths and nodes through which the broadcasted digital messages may pass.

An exemplary implementation of the broadcast system of the present invention is a company having recipients located in remote offices dispersed throughout the country or the world. The root nodes would be located in any of the offices that will broadcast digital messages to the other offices. Each office would include at least one interior node and a plurality of leaf nodes (e.g. one for each of the intended recipients). When a message is broadcast by one of the root nodes, the message is sent (over a long haul network connection) to each of the remote offices, where it is then dispersed to all the leaf nodes therein by the respective interior nodes. With such a broadcast tree, a message is only sent once to any remote office over a long haul network connection, even though there are a plurality of recipient leaf nodes at that remote office. Such a broadcast tree structure reduces the broadcast load on both the root node and the long haul network connection.

The process for creating the secure broadcast system of the present invention is described next, followed by a description of its use.

### Creation of the Secure Broadcast System

Once the various computing devices and network connections for the nodes are installed, the secure broadcast system according to the present invention is created by first defining one or more broadcast groups, following by joining the individual nodes to the defined group.

Defining a Broadcast Group

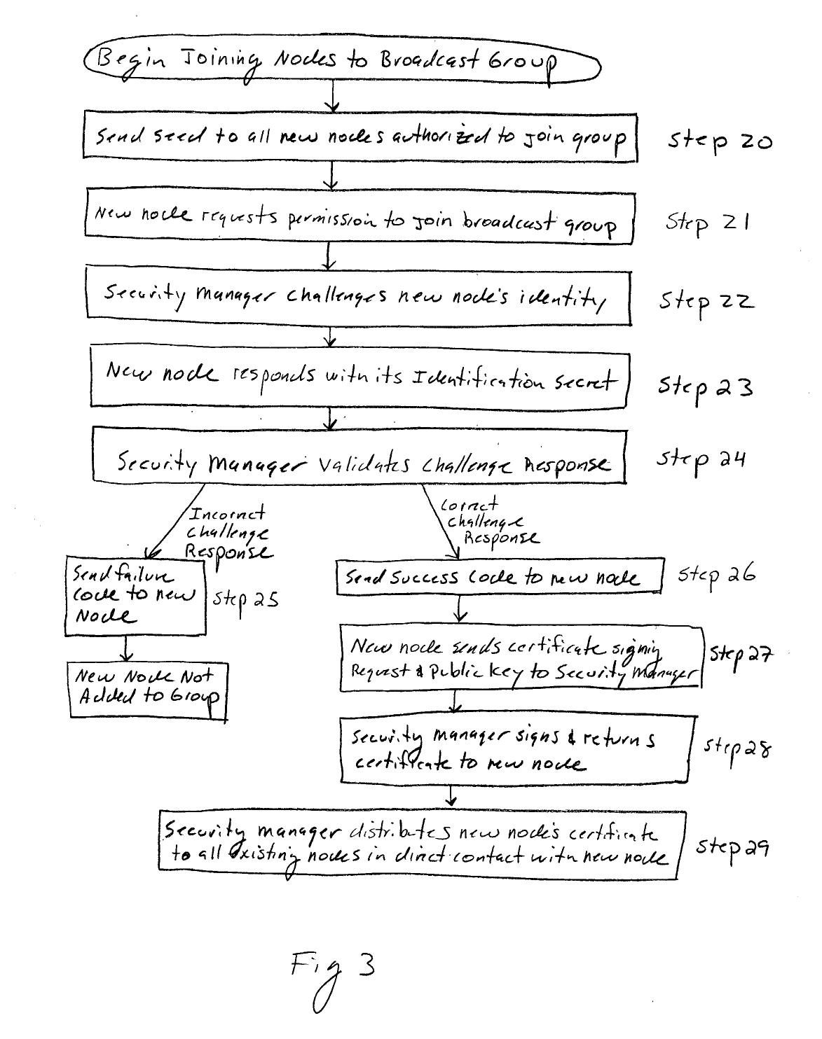

The process steps for defining a broadcast group is described below and illustrated in FIG. 2. This process defines and creates a single broadcast group, and can be repeated to create a plurality of broadcast groups for a single broadcast system.

Each broadcast group is initially defined by creating a unique broadcast group seed (step 10). The seed contains a Globally Unique Identifier (GUID) for the broadcast group, network and protocol information needed to connect to the security manager(s) for the broadcast group, and the public key certificate(s) for the security manager(s).

Nodes are inserted into the group (step 12) by creating a list of all (root, interior and leaf) nodes that shall have permission to join the group. This list of inserted nodes is given to the security manager 12, along with an identification secret associated with each of these nodes so that the node's identification can later be verified. The security manager will preferably perform the task of defining the distribution groups and of joining the nodes to those groups.

Lastly, the distribution tree structure for the inserted nodes is created and sent to the security manager (step 3), whereby the network paths authorized to directly send broadcasted digital messages between the inserted nodes are defined. The created distribution tree structure defines for each node all the possible direct recipient nodes that would be authorized to directly receive broadcasted digital messages from that node. The distribution tree is most likely set up by a human administrator, who takes into consideration the expected location and number of root, interior and leaf nodes, and organizes the distribution tree structure so that the broadcast network will efficiently deliver the broadcasted data throughout the group of recipients. Steps 10, 12 and 14 of FIG. 2 can be performed in any order, including concurrently.

Node insertion is important for security reasons because only those nodes identified in the group defining process will later be allowed to join the group and receive the digital messages broadcasted to that group. Hackers using a non-approved node will simply not get access to the group distribution.

Joining Nodes to a Broadcast Group

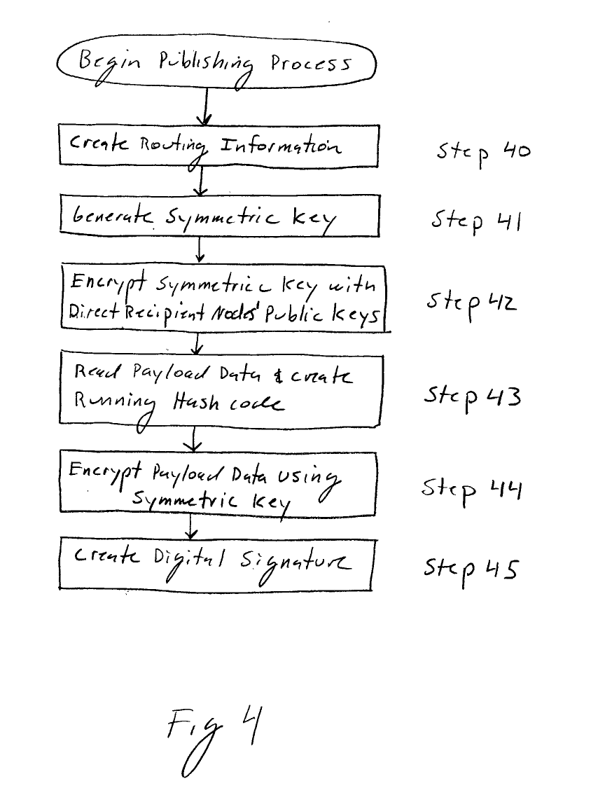

The process for joining nodes to a defined broadcast group is illustrated in FIG. 3, and begins by sending the seed created for the broadcast group to all new nodes that are to join the broadcast group (step 20). These new nodes are those nodes inserted into the group and included in the distribution tree structure in the broadcast group defining process described above.

The mechanism for distributing this seed is ‘out of band’ with respect to the broadcast channel itself (as defined by the broadcast tree), because the broadcast channel being created can not yet be used to securely deliver data (i.e. the seed) to the new nodes. Therefore, mechanisms used to distribute the seed to each new node includes, but are not limited to, floppy disk (also known as “sneaker net”), email, login scripts, web downloads, etc. It will become evident later in this discussion that security of the broadcast system is not compromised should the group seed be distributed to a node that is outside the defined group.

Using network and protocol information in the seed, the new node contacts the security manager and requests permission to join the broadcast group (step 21). This request, and all subsequent communications with the security manager, are encrypted by the new node using the security manager's public key found in the seed file. The new node trusts the security manager(s) in their role as certificate authority and public key infrastructure.

The security manager challenges the new node to identify itself (step 22), requesting its identification secret to authenticate the new node's identity to the security manager. The identification secret for the new node was previously given to the security manager during the node insertion process (see step 12 of FIG. 2). The identification secret could be anything appropriate to a particular domain of computing devices (depending on the desired level of security), such as a password, the node's network card address, the serial number of the computing device hosting the new node, a particular host name, the group's GUID, etc.

The new node responds with an answer to the challenge (step 23), providing its identification secret that proves its identity. The challenge response can be provided automatically by the new node, or require the interaction of a human user to enter and send the answer to the security manager. It is also possible to streamline communications by including the identification secret in the new node's initial request for permission to join the group in step 21.

The security manager then validates that new node's response to the identity challenge (step 24). If the new node responds with an incorrect identity challenge response, the security manager sends a failure code to the new node (step 25), indicating the response was not correct. At this point, the node joining process for the new node ends, and the new node is not considered part of the broadcast group. If the new node responds with the correct identification secret, the security manager sends a success code to the new node (step 26), indicating the response was correct. The new node then creates its own public/private key pair, and sends a certificate signing request along with its public key to the security manager (stet 27). The security manager, acting as a certificate authority, responds to the new node's request by signing the certificate and sending it back to the new node (step 28). The security manager, acting as a public key infrastructure, also distributes the certificate (with the new node's public key) to all existing nodes within the broadcast tree that are to directly communicate with the new node (step 29). The security manager also preferably replicates the certificate to any other security managers should they exist. Thereafter, the new node is deemed joined into the broadcast group, and can thereafter receive broadcast data published to that broadcast group.

It should be appreciated that the node insertion, distribution tree structure definition, and node joining processes can continue to be performed after the broadcast system is up and operating. It is anticipated that nodes and/or data paths will need to be added to, removed from, and moved within, the broadcast tree structure, to accommodate changes in recipients, data traffic patterns and system performance.

### Use of the Secure Broadcast System

Once secure broadcast group(s) have been constructed using the process described above, the broadcast system may then be used to send a secure broadcast. Broadcast data is ‘published’ by a root node, may be ‘relayed’ by one or more interior nodes, and is ‘received’ by a subset or all of the leaf nodes in the group(s).

Each broadcast originates from one of the root nodes of the broadcast tree, and is generally referred to as the “publishing process”. The publishing process produces one output stream (a continuous stream of data), which is generally transmitted from the root node to all of the nodes directly connected to the root node according to the group's broadcast tree.

The output stream is a digital message having a header (containing routing and encryption data) and an encrypted body (containing the main payload of data and a digital signature). As the output stream passes through interior nodes, it is relayed to nodes lower in the broadcast tree without ever decrypting or re-encrypting the message's body, thus preserving the payload data and the original digital signature, which is critical from a security, performance, and scalability perspective.

Only when the data stream reaches a leaf node is the message body decrypted and the digital signature verified. This provides end-to-end security and eliminates air-gaps, meaning that the message's data is encrypted and signed at the root, passes through any interior nodes without decryption, and the encrypted data arrives intact (unmodified) at the leaf node.

The publishing, relay, and leaf node processes are described in more detail below.

The Publishing Process

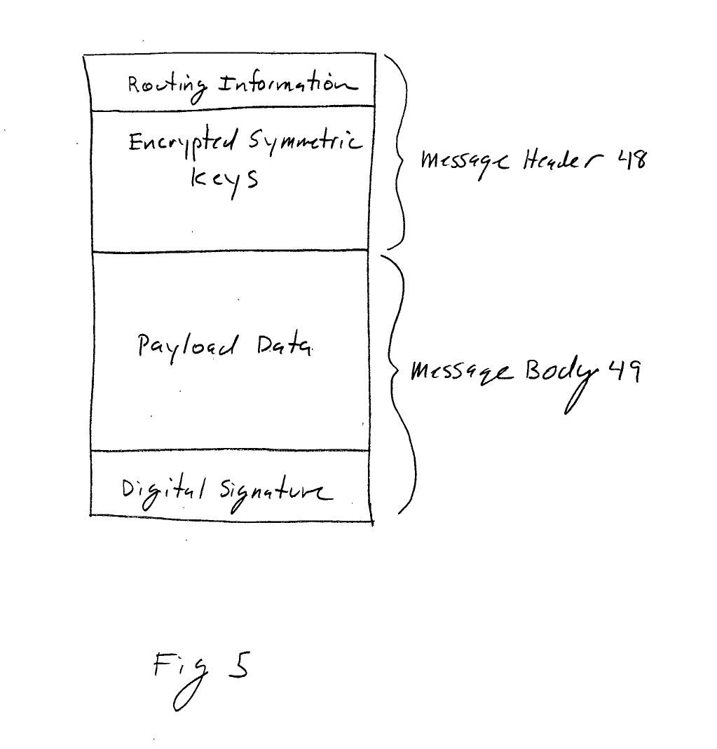

The publishing process is illustrated in FIG. 4, and begins with the root node creating a message header consisting of routing information (step 40). This routing information identifies which leaf nodes in the broadcast group are to receive the broadcast. If the broadcast should be received by all of the broadcast group's leaf nodes, the routing information contains a reserved identifier (e.g., “all=1”) indicating as such. If the broadcast should be received only by a subset of the group's leaf nodes, then the routing information contains a list of GUIDs for only those leaf nodes in the subset.

The payload is encrypted, and a new symmetric key (i.e. a payload key for decrypting the encrypted payload data) is generated by the root node (step 41). This key is generated using standard symmetric key generation algorithms (which are well known in the art) that ensure that this key can not be guessed. This symmetric key generated in step 41 must be securely transmitted to each direct recipient node (as stated above and used herein, for any given node, its “direct recipient nodes” are those nodes lower in the broadcast tree that are authorized to directly receive digital broadcast messages from the one node). This is accomplished by encrypting the symmetric key using each of the direct recipient node(s)' public key (step 42), which can be retrieved from the security manager, or stored locally on the root node. This results in a set of encrypted symmetric keys, one for each of the direct recipient nodes of the root node. The format produced by this step is similar to existing standards including PKCS#7 and S/MIME. The main “payload” data is read from an input stream (step 43). As it is read, a running hash code is maintained which will eventually be used as part of a digital signature. Then, the payload data is encrypted (step 44) using the symmetric key generated in step 41.

Finally, a digital signature is created using the hash code generated in step 43, and by signing with the private key of the root node (step 45). The public key certificate of the root node is included in the digital signature. Preferably, the message's digital signature is also encrypted along with the payload data.

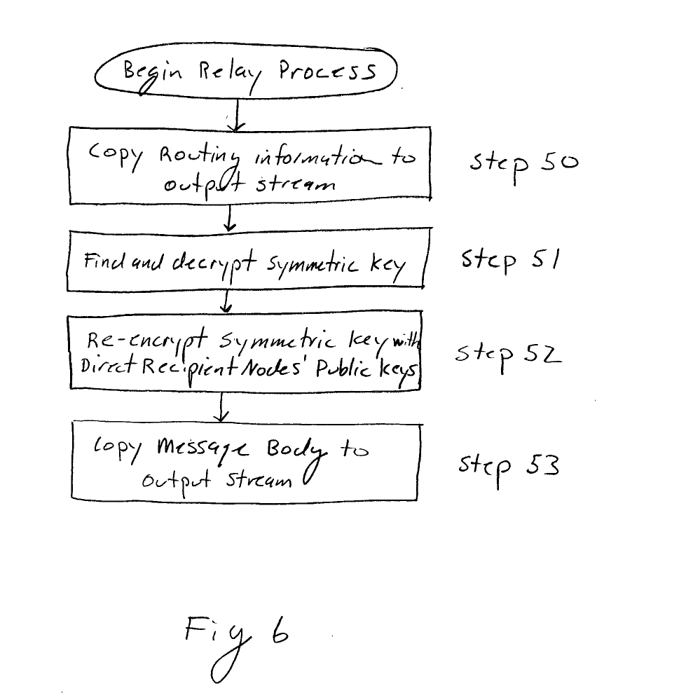

The publishing process described above results in one continuous data stream, which is created by placing the routing information, the encrypted symmetric keys, the encrypted payload data, and the digital signature into the output stream of the root node, preferably as they are generated. As used herein, the term “output stream” refers to the outgoing (sending) side of a network connection. The data stream is part of the top most 7th layer or application layer in terms of the standard OSI 7-layer network protocol stack, meaning that the data stream can be transmitted using any existing network protocol. FIG. 5 illustrates the data format of the digital message published by the root node, which includes a message header 48 (containing the routing information and the encrypted symmetric keys) and a message body 49 (containing the,encrypted payload data and the digital signature).

It is important to note that the same published data stream is sent to all direct recipient nodes of the root node (using any network protocol), unless a screening process described later is deployed. This very fact enables the broadcast process to scale to large numbers of direct recipient nodes, because each direct recipient node does not require a different or separate data stream. Further, the root nodes can break up a large data file (e.g. sizable software program) into smaller payloads for simultaneous publication in a plurality of digital messages.

The Relay Process

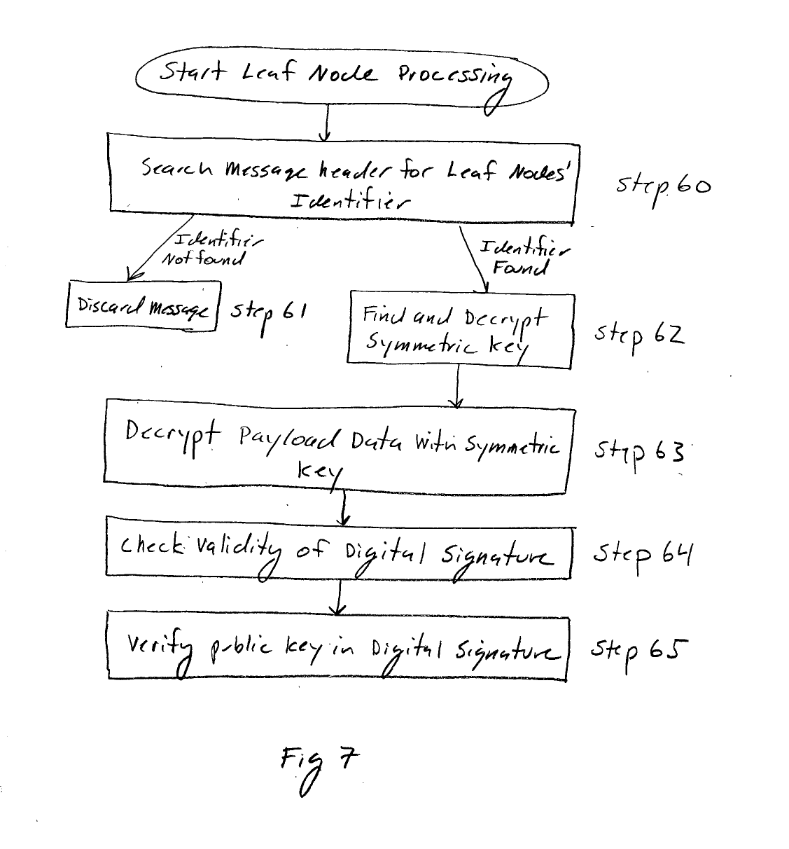

As the published data stream flows through interior nodes in the broadcast tree, the broadcasted message is relayed by the following process, which is illustrated in FIG. 6. As used herein, the term “input stream” refers to the incoming (read) side of a network connection, which is the inverse of the “output stream” previously defined. Both input and output streams for nodes of the present invention are at the 7th or application layer of the 7-layer OSI protocol stack. Preferably, the interior nodes process the incoming broadcast messages on the fly, as they are received, without necessarily waiting for the entire messages to arrive first.

The relay process performed by an interior node begins by reading (from the input stream of the interior node) the routing information from the header of the incoming message, and copying the routing information without modification to the output stream of the interior node (step 50).

Next, the interior node searches the message header for the message's symmetric key that was encrypted with interior node's public key (by the previous node), and uses its private key to decrypt that encrypted symmetric key (step 51). The interior node can use a variety of techniques to isolate its encrypted symmetric key, the worst case approach being a brute force search through all the encrypted symmetric keys looking for one that matches its name value (this process can include decrypting the name values of the different encrypted symmetric keys). Other hints may be added to the message header to improve performance, such as including each recipient's universally unique identifier (UUID) with the symmetric key. Once the interior node finds its encrypted symmetric key, it discards the other encrypted symmetric keys from the message header.

The interior node then re-encrypts the symmetric key, in the same manner as done with the root node (see step 42 of FIG. 4), and copies them to the output stream (step 52). Namely, the symmetric key is encrypted using the public key(s) for each of the interior node's direct recipient node(s) (which can be retrieved from the security manager, or stored locally on the interior node). The new encrypted symmetric keys are copied to the output stream and are included in the header of the relayed message. Finally, the message body containing the encrypted payload data and digital signature is read, and copied to the output stream (step 53).

The above described relay process modifies the header with new encrypted symmetric keys for the new set of direct recipient nodes, but passes the message body along without any modification. Thus, the encrypted payload data and the original digital signature from the root node are retained without modification. Because the encrypted payload data is not decrypted, there are no “air gaps” in the relay process where decrypted data may be stolen.

It should be noted that, depending upon the structure of the broadcast tree, the interior nodes can perform the above described message relay process for any given broadcasted message in parallel, in series, or both. With both parallel and serial connections between interior nodes, there is no upper limit to the number of leaf nodes that may efficiently receive a single broadcast message through a single broadcast tree. By providing multiple interior nodes at the same level of the broadcast tree, broadcast messages can be relayed in parallel. By providing multiple interior nodes at different levels of the broadcast tree, these nodes can be connected to serially relay the broadcast message, thus increasing the effective “fan-out” of the digital message, as well as providing useful protocol conversion.

In any given broadcast system, the network connection paths and the nodes used to disseminate any given broadcast message are dictated by the group's broadcast tree structure. Therefore, messages broadcasts to different groups can utilize different paths and different nodes of the same broadcast system. For example, a particular interior node could have different sets of direct recipient nodes for different groups. Broadcasts of multiple messages to multiple groups can thus be performed efficiently and simultaneously using a single broadcast system. For multi-group broadcast systems, the message header would further include an identifier that indicates which group the message is being broadcasted to, and each of the root/interior nodes would use that identifier to publish/relay the message using the direct recipient nodes for that group.

Leaf node processing

After the relay process is done, the broadcasted message is eventually received by all the leaf nodes in the group, even if only a subset of the leaf nodes in the group are the intended recipients (except if leaf node screening is used as described later). The leaf nodes process the broadcasted message using the steps illustrated in FIG. 7.

When an incoming message is detected, the leaf node applies a search expression to the message header, looking for headers that contain the “all recipients” reserved identifier, or that particular leaf node's GUID (step 60). If the leaf node fails to find either, this indicates the message was not intended for it, and the message is discarded without any further processing (step 61). If the leaf node finds the “all recipients” identifier or its GUID in the message header (indicating this leaf node is an intended recipient), it proceeds to search for and decrypt its encrypted symmetric key from the message header using the leaf node's private key (step 62). This search and decryption is performed in the same manner as described above for the interior nodes (see step 51 of FIG. 6). The leaf node then uses the decrypted symmetric key to decrypt the payload data of the message (step 63). The leaf node can check the validity of the digital signature by calculating the hash code of the decrypted payload data, and comparing that with the hash code included in the digital signature (step 64). The leaf node can also verify that the public key certificate in the digital signature is signed by a certificate authority that they already trust (step 65). This trust relationship is set up during the creation of the broadcast tree, where the security manager gives the leaf nodes the public keys for all authorized root nodes for the group. Steps 64 and 65 are optional, but can be used by the leaf nodes to verify that the message just received was a valid, authorized broadcast from a trusted root node.

Added security can be added to the broadcast system by modifying the symmetric key encryption steps used in the publishing (step 42 of FIG. 4) and relaying (step 52 of FIG. 6) processes described above, to prevent certain leaf nodes in the group from being able to decrypt a received message. This modification to the publishing/relaying processes can be used when the broadcasted message is intended for only a subset of the group's leaf nodes. Should any root or interior node have any direct recipient nodes that are leaf nodes, the root or interior node can search the message's routing information for either the “all recipients” reserved identifier or for the GUID for that direct recipient leaf node. If neither is found, then the root or interior node will not include an encrypted symmetric key in the message header for that particular leaf node. Thus, if all the root and interior nodes perform this screening step, then any leaf node not in the intended subset of recipients will receive the message without an encrypted symmetric key that it can decrypt, and thus it will not have the symmetric key needed to decrypt the encrypted payload data. This added security means the broadcast system does not have to rely on the individual leaf nodes to discard messages not intended for them. Additionally, the load on the nodes and network connections can be further reduced by simply instructing any root or interior node to not even send the message to any direct recipient leaf node that is not identified in the message header as an intended recipient.

The above described broadcast system provides both redundancy, load balancing and broadcast speed that ensures all leaf nodes in the group properly and timely receive the broadcasted messages. The broadcast tree is ideally structured to provide more than one data path (i.e. at some point two copies of the same message are traveling through different combinations of nodes and network connection paths), from each root node to the various leaf nodes in that group. Thus, if an interior node or network connection is down, a broadcasted message will flow through an alternate data path (e.g. alternate interior node(s) and/or network connection(s)). Additionally, the speed of each data path may vary from each other and from time to time, due to the number of interior nodes and network connections involved and the load on those nodes/connection at the time a message is broadcast. Thus, with the broadcast system of the present invention, each leaf node will receive the broadcasted message through the fastest data connection available at that time. If any interior or leaf node receives the same message over alternate data connections, that node will simply disregard subsequent copies of broadcasted messages once the first copy is properly received. The back channel described below may be used by any node to instruct node(s) further up the broadcast tree in the alternate data path(s) to hold a copy of a message that is currently being received via a different data path, or to discard copies of a message already received and confirmed valid via a faster data path. The use of the back channel in this manner serves a load balancing function, where slower data paths having higher data loads are relieved of those data loads by the faster, less loaded data paths. Cycles between interior nodes (i.e. an interior node repeatedly receiving and resending the same message) is prevented by instructing each interior node to ignore any message it has previously received and relayed.

With the broadcast system described above, any interior or leaf node that is off line when a broadcasted message arrives will miss the broadcast. Therefore, the publishing and relay processes can include a store/forward feature, where any root or interior node stores any digital message published or relayed by that node for later retrieval. For example, each node would store and resend any digital message it publishes or relays until it receives confirmation (e.g. via the back channel described below) that all of its direct recipient nodes have received the digital message. Therefore, unlike traditional broadcasts, the store/forward feature ensures that every node that should have received the message will eventually do so, even after the original broadcast is over.

Back Channel

The broadcast tree described above defines a forward broadcast channel for disseminating broadcast messages from an originator (e.g. root node) to recipients (e.g. leaf nodes). In contrast, a secure back channel of the present invention is used to send digital messages from the broadcast recipients back to the broadcast originator. Such digital messages on the back channel can include transit status information confirming the proper receipt of the original broadcasted messages down the broadcast tree, confirmation that a broadcasted software program sent to the recipients (e.g. leaf nodes) was properly installed on remote computing devices and/or the status of the installed software program, quality of service information, billing information, etc.

The back channel of the present invention is created and operated in the same manner as the forward broadcast channel described above, except a back channel tree structure is created that defines data paths allowing the each leaf node to send back channel messages up the back channel tree structure to the originating root node(s). For most applications, the back channel tree structure is simply the reverse of the broadcast tree structure, where each node in the tree structure is given the public key(s) of its direct recipient node(s) above it in the tree structure. For the back channel, messages are published (by the leaf nodes), relayed (by the interior nodes) and processed (by the root node) in the same manner as described above, except the messages are going up the tree structure instead of down it. The message header identifies one or more of the root nodes that shall receive the back channel message. With the back channel formed and operated in this manner, the back channel uses the same data paths as the forward channel.

For some applications, however, it may be preferable that the back channel use different data paths than those used by the forward broadcast channel. For example, with a broadcast tree delivering a single message to thousands or even millions of leaf nodes, the confirmation of receipt messages returning back up the tree could overload the top level interior nodes or the originating root node (in much the same way a denial of service attack overloads a targeted internet website). Therefore, for any given broadcast group, the number and actual paths used for the back channel messages (as defined by the back channel tree structure) can be defined differently relative to the number and actual paths used for the forward broadcast channel (as defined by the broadcast tree structure). For instance, the number of alternate paths near the bottom of the back channel tree structure (nearest the leaf nodes) can be reduced, thus slowing the rate at which back channel messages can reach the top of the back channel tree (nearest the root nodes). Further, certain interior nodes can use a store/forward feature to stager back channel messages, or even be set condense information from back channel messages received from a plurality of leaf nodes into a single message.

It is to be understood that the present invention is not limited to the embodiment(s) described above and illustrated herein, but encompasses any and all variations falling within the scope of the appended claims. For example, while all the network paths shown in FIG. 1 publish or relay messages down the broadcast tree (to lower levels), the broadcast tree structure can include one or more network paths that relay broadcasted messages laterally or even up to a higher node level in the broadcast tree structure (e.g. to provide alternate paths for message distribution).

What is claimed is:

1. A broadcast system, comprising:
a plurality of nodes connected to a network of connection paths for broadcasting digital messages;
the plurality of nodes including:
a root node for publishing the digital messages over the network, wherein each of the published digital messages includes an encrypted payload of data and an encrypted key for decrypting the payload,
an interior node for relaying any of the published digital messages received thereby by decrypting the encrypted key, by re-encrypting the decrypted key, and by relaying the digital message over the network with the re-encrypted key and the encrypted payload, and
a leaf node for processing any of the relayed digital messages received thereby by decrypting the re-encrypted key, and by decrypting the payload using the decrypted key.

2. The broadcast system of claim 1, wherein:
each of the interior and leaf nodes includes a public and a private encryption key associated therewith;
the encrypted key in each of the published digital messages is encrypted with the public key associated with the interior node;
the interior node decrypts the encrypted key with the private key associated with the interior node, and re-encrypts the decrypted key with the public key associated with the leaf node; and
the leaf node decrypts the re-encrypted key with the private key associated with the leaf node.

3. The broadcast system of claim 2, wherein the relaying of any digital messages received by the interior node is performed without decrypting any of the payloads therein.

4. The broadcast system of claim 1, wherein each of the published digital messages include a digital signature of the root node.

5. The broadcast system of claim 4, wherein the root node digital signature of each of the published digital messages includes a hash code generated by the root node using the payload data of the digital message.

6. The broadcast system of claim 4, wherein the root node digital signature is encrypted along with the payload data, and is decrypted by the leaf node using the decrypted key.

7. The broadcast system of claim 1, wherein:
the leaf node publishes back channel digital messages over the network, wherein each of the published back channel digital messages includes an encrypted back channel payload of data and an encrypted back channel key for decrypting the back channel payload;
the interior node relays any of the published back channel digital messages received thereby by decrypting the encrypted back channel key, by re-encrypting the decrypted back channel key, and by relaying the back channel digital message over the network with the re-encrypted back channel key and the encrypted back channel payload, and
the root node processes any of the relayed back channel digital messages received thereby by decrypting the re-encrypted back channel key, and by decrypting the back channel payload using the decrypted back channel key.

8. The broadcast system of claim 7, wherein the relaying of any back channel digital messages received by the interior node is performed without decrypting any of the back channel payloads therein.

9. A broadcast system, comprising:
a plurality of nodes connected to a network of connection paths for broadcasting digital messages;
the plurality of nodes including:
at least one root node, having one or more of the plurality of nodes designated as direct recipient node(s) thereof, for publishing the digital messages over the network only to the direct recipient node(s) of the root node, wherein each of the published digital messages includes an encrypted payload of data and an encrypted payload key for each of the direct recipient node(s) of the root node;
a plurality of interior nodes, each having one or more of the plurality of nodes designated as direct recipient node(s) thereof, for relaying any of the digital messages received thereby by decrypting the encrypted payload key for the interior node, by using the decrypted payload key to create and insert into the digital message an encrypted payload key for each of the direct recipient node(s) of the interior node, and by sending the digital message over the network only to the direct recipient node(s) of the interior node; and
a plurality of leaf nodes each for processing any of the digital messages received thereby by decrypting the encrypted payload key for the leaf node, and by decrypting the payload using the decrypted payload key.

10. The broadcast system of claim 9, wherein each of the digital messages is published by the root node, is relayed by at least one of the interior nodes, and is processed by at least one of the leaf nodes.

11. The broadcast system of claim 9, wherein the direct recipient node(s) of the root node and the interior nodes are selected to provide at least two data paths in the network from the root node to one of the leaf nodes.

12. The broadcast system of claim 9, wherein:
each of the plurality of interior and the plurality of leaf nodes includes a public and a private encryption key associated therewith;
the encryption of the payload key by each one of the root and interior nodes is performed using the public key(s) associated with the direct recipient node(s) of the one root and interior node; and
the decryption of the payload key by each one of the interior and leaf nodes is performed using the private key associated with the one interior and leaf node.

13. The broadcast system of claim 12, further comprising:
a security manager for distributing to the root node the public encryption key for each of the direct recipient node(s) of the root node, and for distributing to each of the interior nodes the public encryption key for each of the direct recipient node(s) of the interior node.

14. The broadcast system of claim 9, wherein the relaying of the digital messages by any of the interior nodes is performed without decrypting any of the payloads therein.

15. The broadcast system of claim 9, wherein the direct recipient node(s) of the root node includes at least one of the leaf nodes.

16. The broadcast system of claim 9, wherein the direct recipient node(s) of one of the interior nodes includes another of the plurality of interior nodes.

17. The broadcast system of claim 9, wherein the direct recipient node(s) of one of the interior nodes includes at least one of the leaf nodes.

18. The broadcast system of claim 17, wherein the digital messages include a header that identifies which ones of the plurality of leaf nodes are intended recipients of the digital message, and wherein each of the interior nodes withholds the sending of the digital message to any of the direct recipient node(s) thereof that are leaf nodes and are not identified as intended recipients of the digital message.

19. The broadcast system of claim 9, wherein each of the leaf and interior nodes is designated in at least one of a plurality of distribution groups, and wherein the direct recipient node(s) of the root node and interior nodes vary from one of the distribution groups to another of the distribution groups.

20. The broadcast system of claim 9, wherein the direct recipient node(s) of the root node and the plurality of interior nodes define a broadcast tree structure of authorized network connection paths for broadcasting the digital messages from the root node to the leaf nodes.

21. The broadcast system of claim 9, wherein each of the published digital messages includes a digital signature of the root node.

22. The broadcast system of claim 21, wherein the root node digital signature of each of the digital messages includes a hash code generated by the root node using the payload data of the digital message.

23. The broadcast system of claim 21, wherein the root node digital signature of each of the published digital messages includes a hash code generated by the root node using the payload data of the digital message.

24. The broadcast system of claim 9, wherein at least one of the interior nodes stores at least one of digital messages received thereby until all of the direct recipient node(s) of the interior node have received the relayed digital message from the interior node corresponding to the at least one received digital message.

25. The broadcast system of claim 9, wherein:
the plurality of leaf nodes each have one or more of the plurality of nodes designated as back channel direct recipient node(s) thereof, and each of the plurality of leaf nodes generates back channel messages for publishing over the network only to the back channel direct recipient node(s) thereof, wherein each of the published back channel digital messages includes an encrypted back channel payload of data and an encrypted back channel payload key for each of the back channel direct recipient node(s) of the leaf node;
the plurality of interior nodes each have one or more of the plurality of nodes designated as back channel direct recipient node(s) thereof, and each of the plurality of interior nodes relays any of the back channel digital messages received thereby by decrypting the encrypted back channel payload key for the interior node, by using the decrypted back channel payload key to create and insert into the back channel digital message an encrypted back channel payload key for each of the back channel direct recipient node(s) of the interior node, and by sending the back channel digital message over the network only to the back channel direct recipient node(s) of the interior node; and
the root node processes any of the back channel digital messages received thereby by decrypting the encrypted back channel payload key for the root node, and by decrypting the back channel payload using the decrypted back channel payload key.

26. The broadcast system of claim 25, wherein the relaying of the back channel digital messages by any of the interior nodes is performed without decrypting any of the back channel payloads therein.

27. The broadcast system of claim 25, wherein:
the root node and each of the plurality of interior nodes includes a public and a private encryption key associated therewith;
the encryption of the back channel payload key by each one of the leaf and interior nodes is performed using the public key(s) associated with the back channel direct recipient node(s) of the one leaf and interior node; and
the decryption of the back channel payload key by each one of the interior and root nodes is performed using the private key associated with the one interior and root node.

28. The broadcast system of claim 27, further comprising:
a security manager for distributing to each of the leaf nodes the public encryption key for each of the back channel direct recipient node(s) of the leaf node, and for distributing to each of the interior nodes the public encryption key for each of the back channel direct recipient node(s) of the interior node.

29. A method of creating a secure broadcast group for a broadcast system having a plurality of nodes connected to a network of connection paths, the method comprising the steps of:
defining a broadcast group by designating at least some of the plurality of nodes as authorized nodes for joining the group, and by designating for each of the authorized nodes which of the authorized nodes are allowed to receive broadcast messages therefrom; and
joining the authorized nodes to the group by conveying to each of the authorized nodes an identity and a public encryption key of any of the authorized node(s) designated as allowed to receive broadcast messages therefrom.

30. The method of claim 29, wherein the joining of each one of the authorized nodes to the group is triggered by a request from the one node to a security manager.

31. The method of claim 30, wherein the defining of the broadcast group further includes the steps of:
creating a seed file containing connection information and a public encryption key for the security manager; and
disseminating the seed file to the authorized nodes.

32. The method of claim 31, wherein each of the authorized nodes has an identification secret corresponding thereto, and wherein the defining of the broadcast group further includes the step of:
conveying to the security manager an identity and the identification secret for each of the plurality of nodes that are designated as authorized nodes.

33. The method of claim 32, wherein the joining of any one of the authorized nodes to the group is performed by the security manager only after the one authorized node provides its identification secret the security manager.
